(19) United States
(12) Patent Application Publication
(10) Pub. No.: US 2003/0099842 A1
(43) Pub. Date: May 29, 2003

(54) Transparent substrate comprising metal elements and use thereof

(76) Inventors: Georges Za-Gdoun, La Garenne Colombes (FR); Benoit Rogier, Paris (FR); Veronique Rondeau, Drancy (FR)

Correspondence Address: PENNIE & EDMONDS LLP, 1667 K STREET NW, SUITE 1000, WASHINGTON, DC, 20006

(21) Appl. No.: 10/280,002

(22) Filed: Oct. 25, 2002

Related U.S. Application Data
(63) Continuation of application No. PCT/FR01/01107, filed on Apr. 11, 2001.

(30) Foreign Application Priority Data
Apr. 26, 2000 (FR) FR 00/05284

(51) Int. Cl. B32B 9/00

(52) U.S. Cl. 428/432; 428/697; 428/701; 428/702; 428/433; 428/434

(57) ABSTRACT

A transparent substrate is provided with metal components, such as metal wires and/or a stack of thin layers including at least one silver layer, to prevent the transmission of waves in the near infrared.

### CROSS-REFERENCE TO RELATED APPLICATIONS

This application is a continuation of the U.S. National Stage designation of co-pending International Patent Application PCT/FR01/01107, filed Apr. 11, 2001, the entire contents of which are expressly incorporated herein by reference thereto.

### FIELD OF THE INVENTION

The invention relates to a transparent substrate, in particular of glass, comprising metal components which can act on infrared radiation of high wavelength.

### BACKGROUND OF THE INVENTION

The invention will be described more particularly for the use of a substrate in a plasma screen; nevertheless, it is not restricted to such an application, it being possible for the substrate to be inserted into any electromagnetic screening wall.

A plasma screen comprises a plasmagen gas trapped between two glass sheets and luminophores positioned on the internal face of the rear sheet of the screen. During operation of the screen, interactions between the particles of the plasmagen gas and the luminophores generate radiation with electromagnetic waves which are situated in the near infrared between 800 and 1000 nm, the propagation of which, mainly through the front face of the screen, can be the source of highly troublesome disruption, in particular for equipment situated close by and controlled by infrared, for example by means of remote controls.

Furthermore, like all electronic equipment, plasma screens have drivers which can generate spurious radiation with respect to other devices with which they must not interfere, such as microcomputers, portable telephones, and the like.

In order to halt and at least reduce the propagation of this radiation, one solution involves positioning, against the front face of the screen, a simultaneously transparent and metallized window for providing electromagnetic screening.

One known type of window consists of two poly(vinyl butyral) (PVB) sheets, between which is maintained, by adhesive bonding, a homogeneous metal mesh formed by the weaving of metal wires which are directed along two substantially perpendicular directions and which exhibit a thickness of approximately 50 μm, the openings of the mesh exhibiting a square surface area of approximately 0.12 mm². However, this solution for large screen sizes is unsatisfactory, in particular because of a slight flexibility of PVB and the need to tension the metal fabric during the laminating stage, which can result in problems of distortion of the openings in the laminate.

Another solution instead involves deposition of the metal mesh directly onto a glass substrate by a conventional photolithographic technique and joining this substrate to the front face of the screen.

Whether it is by one solution or the other, the mesh is generally superimposed so that the metal wires are parallel to the edges of the screen, which forces the horizontal wires to be orthogonal to the pixels of the screen. However, this arrangement of the mesh can produce a moire effect when an observer looks at the screen at a certain angle, providing him with a significant visual nuisance.

To limit the moiré effect that may be produced, an angled arrangement of the mesh is preferred, that is to say that the two substantially perpendicular directions of the metal wires are established substantially at 45° with the pixels of the screen. Nevertheless, this improvement by such an arrangement is sometimes not entirely satisfactory.

Another alternative solution to the moire problem, known from Patent Application FR 2 781 789, is the production of a mesh of corrugated metal wires which is inserted into a PVB sheet, itself combined with a glass substrate. The inventive characteristic involves arranging two adjacent wires with the same orientation so that the corrugation of one is phase shifted with respect to the corrugation of the other.

Returning to the problem of transmission in the infrared, the properties of reflection in the infrared, as possessed by metal conductors and in particular silver, are known. This is why, in order to increase the electromagnetic screening effect obtained by a substrate, such as that disclosed in Patent Application FR 2 781 789, a glass substrate combined with a metal mesh incorporated in the PVB advantageously is provided with at least two silver layers with a thickness equivalent to approximately 10 nm. The layers are positioned between two layers of dielectric material of the metal oxide type, thereby preventing detrimental change in the silver during its deposition when the latter is carried out by the cathodic sputtering technique.

In order to confer additional characteristics on such a substrate, such as characteristics of an aesthetic nature so that it can be curved for applications other than a plasma screen, or characteristics of a mechanical nature so that it is stronger, or characteristics of a safety nature so that it does not cause injury in the event of breaking, the glass substrate is subjected to heat treatments of the bending, annealing or toughening type. In order to retain the integrity of a functional layer, such as silver, in particular to prevent its detrimental change during heat treatments, a stack of thin layers is devised in a known way such that it exhibits, for example, the following sequence:

Glass/SnO₂/ZnO/Ag/ZnO/Si₃N₄/ZnO/Ag/ZnO/Si₃N₄.

Although the substrate, in particular Patent FR 2 781 789, improves the electromagnetic screening and the moiré problem, it is always desirable to improve even further the properties of the existing solutions.

An aim of the invention is thus to avoid the disadvantage of the transmission of electromagnetic waves in the infrared region, in particular through a plasma screen, and to overcome the moiré problem when a metal mesh is provided in the context of electromagnetic screening, while achieving satisfactory light transmission. To this end, a transparent substrate possessing metal components is provided with characteristics and properties which prevent the transmission of waves in the near infrared.

### SUMMARY OF THE INVENTION

According to a first embodiment of the invention, a transparent substrate, in particular of glass, is equipped with a stack of thin layers comprising at least two metal layers with properties in the infrared region, with a thickness t₁ for that closest to the substrate and with a thickness t₂ for the other, the ratio of the thicknesses t₁/t₂ being between 0.8 and 1.1, preferably between 0.9 and 1, with the overall thickness of metal layers t₁+t₂ being between 27 and 30 nm, preferably between 28 and 29.5 nm, a protective metal layer being placed immediately above and in contact with each layer with properties in the infrared region, and with the resistance per square of the substrate being less than 1.8 Ω.

The protective metal layer is preferably based on a single metal chosen from niobium Nb or titanium Ti.

This configuration makes it possible, first, by the increase in the thickness of metal with respect to the approximately 10 nm thickness of the prior art, to increase the electromagnetic screening and to simultaneously decrease the transmission in the near infrared so as to be at most 15% and for the most part below 10%. Secondly, by a symmetry in the thickness of the layers, it is possible to obtain satisfactory quality of the light transmission T_{L} of at least 65% and rather greater than 67%. For the application of such a substrate to a plasma screen, the symmetry in thickness of the metal layers does not cause disturbance with regard to the visual appearance in reflection external to the screen when an observer looks at the screen along distinct angles of incidence, as is generally the case in the construction industry for which the glazing surface area is certainly greater.

The stack of thin layers can advantageously exhibit the following sequence:

Glass/Si₃N₄/ZnO/Ag/Ti/Si₃N₄/ZnO/Ag/Ti/ZnO/Si₃N₄.

A TiO₂ layer can be added after the Si₃N₄ layer on the substrate, so as to “wash” the colour of the front face of the substrate in reflection and thus resulting in a neutral aesthetic product having an excellent colorimetric rendering.

The substrate of the invention also very advantageously endures a toughening or bending heat treatment.

According to one aspect, the thin layers are connected to one another and intended to be connected to earth in the event of use of the substrate in electrical equipment.

According to a second embodiment of the invention, the transparent substrate, in particular of glass, includes a network of metal wires which is provided in the form of a mesh. The metal wires are deposited according to a thickness t and a width w. The thickness t of the wires is between 80 nm and 12 μm, preferably between 200 nm and 1 μm, and the width w of the wires is between 10 and 60 μm, preferably between 15 and 35 μm.

According to one aspect, the metal wires are formed of copper or silver.

According to another aspect, the wires intertwine to form a multiplicity of openings O, the dimensions of which are not uniform over the surface of the substrate, making it possible to greatly weaken the moire effect. The length of the outline of an opening side can vary between 250 and 750 μm.

In order to confer improved electromagnetic screening properties on the combined substrate and screen while retaining satisfactory optical properties for the level of transparency desired for the substrate, care should be taken to appropriately select the thickness and the width of the metal wires with respect to the surface areas of the openings

A satisfactory compromise between the dimensions of the openings and the thickness and width of the metal wires makes it possible to weaken the electromagnetic waves between 30 and 1 100 MHz by at least 30 dB. With this aim, the ratio of the overall surface area of the openings to the surface area of the wire's deposition is greater than 65%, and the substrate exhibits a diffuse transmission of less than 2%.

To further reduce the moiré effect, the substrate, which is substantially parallelepipedal in shape, may be provided with the metal wires being positioned at an angle with respect to the edges of the substrate.

The technique for producing the substrate comprising the metal wires, in particular, involves photolithography. Photolithography makes it possible to produce very thin wires, in particular of less than 40 μm in width, which then renders the wires virtually invisible to the observer. Another advantage of photolithography lies in the ability to fully control both the various shapes and dimensions of the openings to be obtained, which cannot be envisaged by a weaving technique such as that used for the mesh held between two PVB sheets. In addition, because the size of the wires has a direct influence on the diffuse transmission of the substrate, that is to say the fuzziness of the screen noticeable by an observer, the wire thinness beneficially reduces the fuzziness effect.

The metal wires are preferably connected to one another via a metal strip intended to be connected to electrical earth, in particular during assembly of the substrate on a plasma screen. The electrical connection of the wires to the substrate is advantageously carried out during the photolithography stage.

According to a third embodiment, the substrate comprising the metal wires as defined above and is combined with another transparent substrate comprising, on one of its faces, a stack of thin layers facing the metal mesh, with the stack comprising at least one conductive metal layer of the silver type. In an alternative form, the same substrate comprises the metal wires on one of its faces, and on the opposite face has a stack of thin layers comprising at least one conductive metal layer of the silver type.

According to one aspect of this last embodiment, the combined substrate exhibits the characteristics of the substrate of the first embodiment.

For the use in particular of a substrate of the invention positioned against a plasma screen, the addition of an antireflection coating to the external face of the substrate is indicated. In addition, with regard to safety, it will be preferable to produce a laminated substrate by covering the metal wires or the stack of thin layers with a thermoplastic film.

### BRIEF DESCRIPTION OF THE DRAWINGS

Preferred features of the present invention are disclosed in the accompanying drawings, wherein similar reference characters denote similar elements throughout the several views, and wherein:

FIG. 1 shows a cross-sectional side view of a transparent window according to a first embodiment of the invention, combined with a plasma screen;

FIG. 2 shows a cross-sectional side view of a transparent window according to a second embodiment of the invention, combined with a plasma screen;

FIG. 3 shows a cross-sectional side view of an alternate embodiment of the transparent window and plasma screen of FIG. 1;

FIG. 4 shows a cross-sectional side view of an alternate embodiment of the transparent window and plasma screen of FIG. 2;

FIG. 5 shows a cross-sectional side view of a transparent window according to a third embodiment of the invention, intended to be combined with a plasma screen;

FIG. 6 shows a graphical representation of the light transmission of a substrate according to various ratios of thicknesses of metal layers;

FIG. 7 shows a graphical representation of the transmission of infrared radiation according to the overall thickness of the metal layers;

FIG. 8 shows a partial top view of a metal mesh according to the invention;

FIG. 9 shows a graphical representation of electromagnetic attenuation curves corresponding to various models of metal meshes; and

FIG. 10 shows a graphical representation of the light transmission and light scattering for the models of meshes referenced in FIG. 9.

### DETAILED DESCRIPTION OF PREFERRED EMBODIMENTS

First, it should be noted that the proportions relating to the various quantities, in particular thicknesses, of the components of the invention are to scale in the drawings in order to facilitate an understanding of the invention.

Each of FIGS. 1 to 5 shows a transparent window 1 intended to be joined to the front face of a plasma screen E.

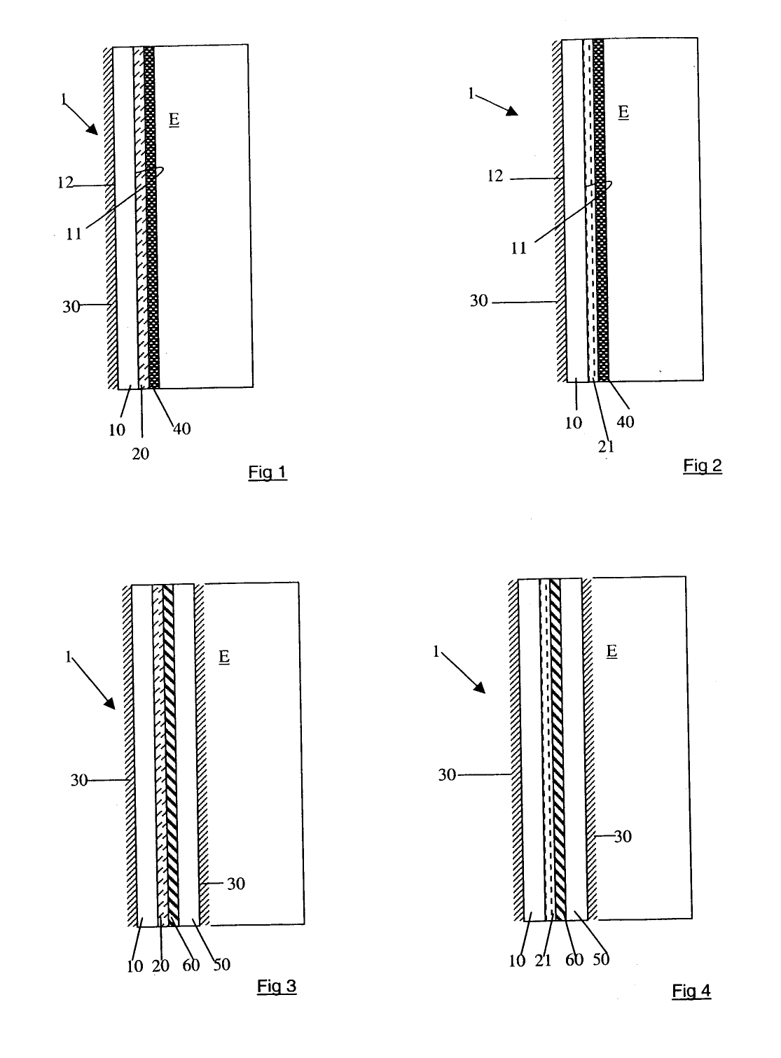

In FIGS. 1 and 2, the transparent window 1 is formed of a single substrate, such as a glass sheet 10, on which are deposited metal components 20 or 21 having electromagnetic screening properties.

In FIGS. 3 and 4, which are respectively alternative forms of FIGS. 1 and 2, the transparent window 1 is formed of laminated glass in order to confer mechanical strength thereon and thus to safeguard the screen in the event of breakage of the front face of the window.

According to the first embodiment, the metal components 20 are formed of at least two electrically conductive functional layers of Ag type. These metal layers are inserted into a stack of thin protective layers, a preferential sequence of which is as follows:

Glass/Si₃N₄/ZnO/Ag/Ti/Si₃N₄/ZnO/Ag/Ti/ZnO/Si₃N₄.

The Ti layer constitutes a protective metal layer for the silver, preventing in particular the oxidation of the silver.

A TiO₂ layer can be inserted between the Si₃N₄ and ZnO layers close to the glass, so as to “wash” the colour of the substrate in reflection.

All the layers of the stack are deposited by a known cathodic sputtering technique on the internal face 11 of the substrate that is intended to be facing the screen.

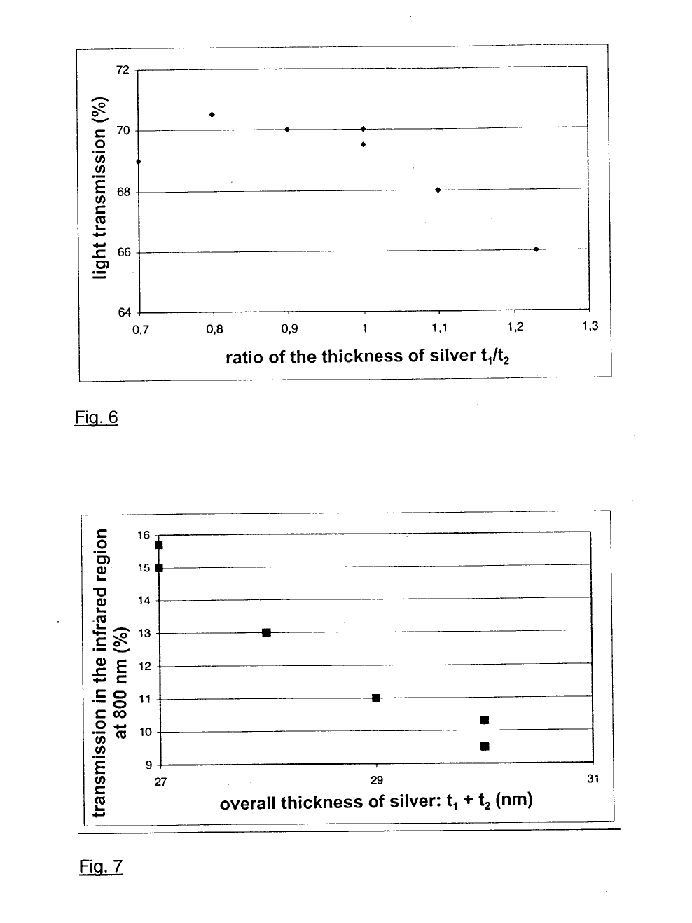

The first metal layer, of Ag, positioned closest to the substrate, exhibits a thickness t₁ substantially equivalent to the thickness t₂ of the second metal layer, of Ag, so that the ratio of the thicknesses t₁/t₂ is between 0.8 and 1.1 and preferably between 0.9 and 1. Thus, the light transmission is highly suitable, greater than 67% as visible light according to FIG. 6. The points on this graph correspond to various substrate samples for which the ratio of the thicknesses varies from 0.7 to 1.25, with the substrate having a stack of the type of that preferably given.

The thicknesses t₁ and t₂ are much greater than those of the state of the art, in order to increase the overall thickness t₁+t₂ of metal on the substrate so as to increase the electromagnetic screening and to decrease the transmission of infrared radiation from the screen toward the outside of the substrate.

Thus, the overall thickness t₁+t₂ of the metal layers is between 27 and 30 nm. To obtain good reflection of infrared radiation toward the screen, that is to say for the least possible radiation to pass through the substrate, an overall thickness of the metal layers of between 28 and 29.5 nm preferably is chosen, with the transmission of the radiation thus not exceeding 13% for a wavelength of 800 nm.

By controlling the deposition of the functional metal and dielectric layers and the thicknesses which are formulated according to the invention, and by the use of protective metal layers, the resulting substrate very advantageously exhibits a low resistance of less than 1.8 Ω/□. In addition, the substrate withstands any toughening or bending heat treatment.

An example of the thickness values of the various thin layers of the stack, with thicknesses t₁ and t₂ of 14 nm, is given in Table 1 below:

TABLE 1

| Glass | Thickness (nm) |
|---|---|
| Si₃N₄ | 20 |
| TiO₂ | 5 |
| ZnO | 10 |
| Ag | 14 |
| Ti | 1.5 |
| Si₃N₄ | 73 |
| ZnO | 10 |
| Ag | 14 |
| Ti | 1.5 |
| ZnO | 10 |
| Si₃N₄ | 22.5 |

The external face 12 of glass substrate 1 can be furnished with an antireflection coating 30.

The attachment of substrate 1 to the front face of the screen is carried out, for example, by means of a double-sided adhesive 40. The adhesive is positioned on the peripheral edge of internal face 11 of the substrate or else is provided in the form of a film stretched out over virtually all of internal face 11 of the substrate.

In a second embodiment of the invention, metal components 21 are formed of a network of metal wires, of Cu or Ag, provided in the form of a mesh. The metal wires are deposited on internal face 11 of glass substrate 10 using a known photo-lithographic technique. The external face 12 can receive an antireflection coating 30. As regards the attachment of the substrate to the front face of the screen, it can also be carried out as explained above using an adhesive film 40.

The metal wires are preferably positioned according to two substantially perpendicular directions and define a multitude of openings O (FIG. 8). The wires can be straight, can exhibit a sinusoidal shape or can exhibit any other geometrical shape.

The electromagnetic screening is strengthened by increasing the volume of metal of the mesh. To this end, it is possible to vary the width w and/or the thickness t of the wires. The wires of the entire mesh can have the same width and the same thickness but it is also possible to vary these characteristics from one point of the substrate to another. The photo-lithographic method is particularly valuable as it makes it possible to completely control the thickness and width of the metal deposit, and to be able to easily produce additional components, such as bus bars. Methods equivalent to photolithography, such as photogravure or photoenamelling, can be employed.

The width w of the wires is between 10 and 60 μm. The thickness t of the wires is between 80 nm and 12 μm.

The increase in volume of the metal on the substrate, namely the increase by the width and/or the thickness of the metal wires, increases the electromagnetic screening. The electromagnetic screening becomes more satisfactory in proportion as the aperture surface area decreases. However, it is necessary to take into account the overall aperture surface area by which the infrared radiation is transmitted, which surface area corresponds to the overall surface area of the combined openings O of the mesh. This is because the overall aperture surface area participates directly in the light transmission, which has to be sufficiently high to read the screen in a transparent manner through the substrate.

Consequently, a compromise has to be made between the overall surface area of the openings O and the volume of metal deposited in order to provide suitable electromagnetic screening while retaining correct light transmission.

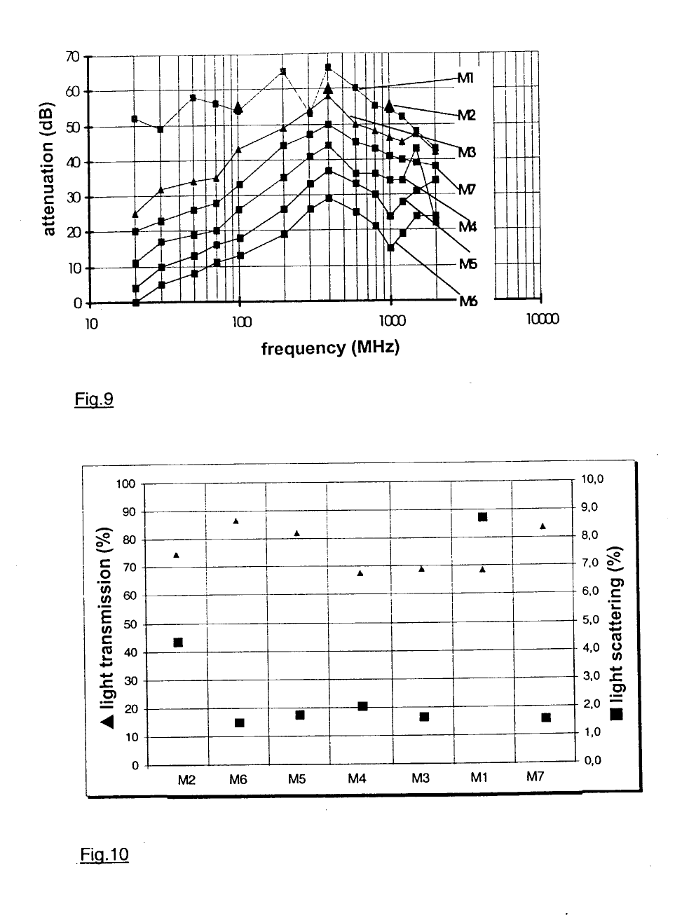

FIG. 9 reproduces, for frequencies of between 20 and 1 100 MHz, the curves of the attenuation in dB generated by various mesh models with square openings O, the sides of which, defined by the distance separating the internal edges of two opposite wires, are between 250 and 750 μm.

The various models M1 to M7 are summarized in Table 2 below:

TABLE 2

| Mesh model/Metal | Width w | Thickness t | | Side of the opening | |
|---|---|---|---|---|---|
| M1/Cu | 12 μm | 12 | μm | 250 | μm |
| M2/Cu | 50 μm | 50 | nm | 350 | μm |
| M3/Cu | 60 μm | 250 | nm | 350 | μm |
| M4/Ag | 60 μm | 80 | nm | 350 | μm |
| M5/Ag | 60 μm | 120 | nm | 750 | μm |
| M6/Ag | 60 μm | 120 | nm | 1.5 | mm |
| M7/Ag | 30 μm | 200 | nm | 420 | μm |

FIG. 10 relates to the measurements of light transmission and light scattering (also known as diffuse transmission) of substrates comprising the mesh models referenced M1 to M7 of FIG. 9.

Although systems M5 and M6 are satisfactory with respect to light transmission (which is greater than 80%) and scatter only a small amount of light (less than 2%), they do not, however, perform well with respect to the electromagnetic screening (attenuation of less than or approximately 30 dB only according to FIG. 9).

The model M1 has a very good performance with regard to screening (attenuation of approximately 55 dB) but produces light scattering, namely a fuzziness of the image, which is much too high, of the order of 9%.

In contrast, model M7 is correct with a screening of greater than 30 dB, up to close to 50 dB for frequencies of the order of 400 MHz, and has a light transmission of greater than 80% with a scattering of approximately 1.5%.

Consequently, the preferred values of the dimensions of the wires are: a width w of wires of between 15 and 35 μm and a thickness t of between 200 nm and 1 μm. Furthermore, the dimensions of the openings O are defined so that the light transmission or alternatively the ratio of the overall surface area of the openings, that is to say the aperture surface area for the transmission of light, to the deposition surface area of the wires, that is to say the surface area for which the transmission of light is prevented, is greater than 65%, while introducing a diffuse transmission of less than 2%.

Furthermore, in order to reduce the moiré effect existing when an observer looks at the screen at a certain angle, the mesh is preferably positioned at an angle with respect to the edges of the substrate, so that the wires of the mesh substantially form an angle of 45° with the pixels of the screen.

For the purpose of optimizing the decrease in the moire effect, the openings O of the mesh exhibit variable dimensions, resulting in variable aperture surface areas. This nonuniformity of the openings, obtained by a greater or lesser spacing of the wires from one another, succeeds in considerably reducing the moire effect.

In the alternative forms of the two separate embodiments (FIGS. 3 and 4), window 1 is a laminated glass. The window comprises a sheet of glass 10 situated as a front face and serving as the substrate for the metal components, which correspond to the stack of layers 20 in FIG. 3 and to the mesh 21 in FIG. 4. Another sheet of glass 50 is situated as a rear face intended to be facing the screen, and a sheet of thermoplastic polymer 60 which is based for example on PVB is inserted between the two sheets of glass.

The external face of the sheets of glass 10 and 50 is advantageously provided with an antireflection coating 30.

The laminated window is attached to the screen by clip-fastening means (not represented) or by any other conventional means.

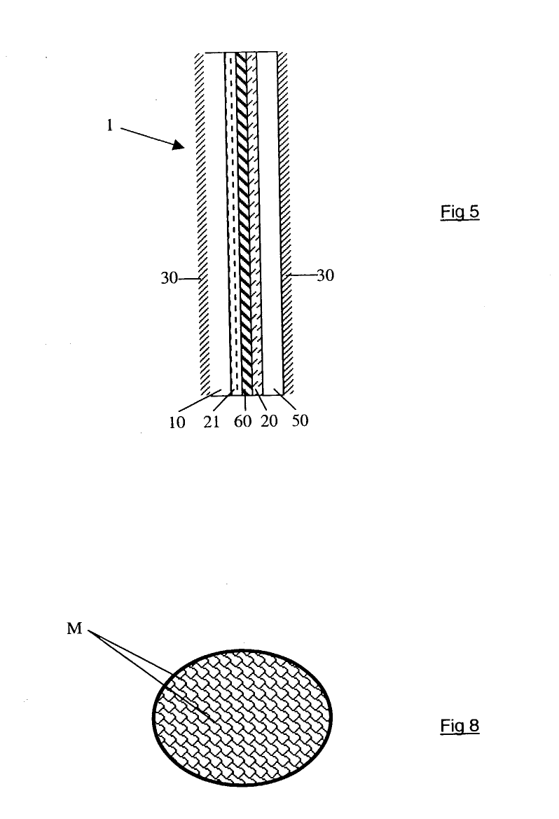

Lastly, in a final embodiment illustrated in FIG. 5, the metal mesh defined in the second embodiment is combined with a stack of thin layers 20 of the first embodiment.

Thus, window 1 comprises: a sheet of glass 10 serving as the substrate for the metal mesh 21, a sheet of glass 50 serving as the substrate for the stack of thin layers furnished with two layers of silver which exhibit the same thickness characteristics explained above, and a sheet of thermoplastic polymer 60 separating the metal mesh 21 from the stack of layers 20 so as to act as a protective film with respect to the layers and to introduce lamination to the window.

The presence of the metal layers, of silver, adds an amount of metal to that already existing by virtue of the mesh; as the layers of silver are particularly suitable for halting the transmission of wavelengths in the infrared region, this configuration accordingly improves the electromagnetic screening of the screen.

The external faces of the two sheets of glass 10 and 50 are advantageously furnished with an antireflection coating 30.

The laminated window is attached to the screen by clip-fastening means, the front face of the window corresponding without distinction to the substrate carrying the mesh 21 or that furnished with the stack of layers 20.

It is obvious that the latter embodiment, the aim of which is to optimize the embodiment with a metal mesh, in an alternative form can combine the embodiment with a mesh and an embodiment using two layers of silver with unsymmetrical thicknesses, as known in the prior art, for example with t₁=13 nm and t₂=9 nm, or alternatively using a single layer of silver instead of two layers of silver. In addition, the use of only a single substrate comprising, on one of its faces, the metal mesh and, on the other face, the metal layer or layers, can be envisioned.

The metal components of the various embodiments described, metal layers and/or metal mesh, are connected by electrically conductive means to a metal point of the screen connected to earth for the purpose of earthing all the metal components.

What is claimed is:

1. A transparent substrate comprising at least two metal layers having properties in the infrared region, the metal layer closest to the substrate having a thickness t₁ and a second metal layer having a thickness t₂, wherein the ratio of thicknesses t₁ to t₂ is between 0.8 and 1.1, the sum of thicknesses t₁ and t₂ is between 27.5 and 30 nm, a protective metal layer abuts each metal layer and has properties in the infrared region, and the resistance per square of the substrate is less than 1.8 Ω.

2. The transparent substrate of claim 1, wherein the ratio of thicknesses t₁ to t₂ is between 0.9 and 1.

3. The transparent substrate of claim 1, wherein the sum of thicknesses t₁ and t₂ is between 28 and 29.5 nm.

4. The transparent substrate of claim 1, wherein the protective metal layer is formed of a single metal chosen from niobium or titanium.

5. The transparent substrate of claim 1, wherein the metal layers are subjected to a toughening or bending heat treatment.

6. The transparent substrate of claim 1, wherein the substrate has a light transmission of greater than 65%.

7. The transparent substrate of claim 1, wherein the substrate has a transmission in the near infrared of no more than 15%.

8. The transparent substrate of claim 1, wherein the substrate with metal layers and protective metal layers comprises the sequence
Glass/Si₃N₄/ZnO/Ag/Ti/Si₃N₄/ZnO/Ag/Ti/ZnO/Si₃N₄.

9. The transparent substrate of claim 1, wherein the substrate with metal layers and protective metal layers comprises the sequence
Glass/Si₃N₄/TiO₂/ZnO/Ag/Ti/Si₃N₄/ZnO/Ag/Ti/ZnO/Si₃N₄.

10. The transparent substrate of claim 1, further comprising an antireflection coating.

11. A transparent substrate comprising a transparent sheet with a network of metal wires deposited thereon in the form of a mesh, wherein the metal wires have a thickness between 80 nm and 12 μm and a width between 10 and 60 μm.

12. The transparent substrate of claim 11, wherein the metal wires have a thickness between 200 nm and 1 μm.

13. The transparent substrate of claim 11, wherein the metal wires have a width between 15 and 35 μm.

14. The transparent substrate of claim 11, further comprising a second transparent sheet having a stack of thin layers including at least one conductive metal layer formed of silver, wherein the at least one conductive layer faces the mesh.

15. The transparent substrate of claim 14, wherein the stack of thin layers further includes an antireflection coating.

16. The transparent substrate of claim 14, further comprising a sheet of thermoplastic material covering the stack of thin layers.

17. The transparent substrate of claim 14, wherein the stack of thin layers comprises at least two metal layers having properties in the infrared region, the metal layer closest to the substrate having a thickness t₁ and a second metal layer having a thickness t₂, wherein the ratio of the thicknesses t₁/ t₂ is between 0.8 and 1.1 and the sum of the thicknesses t₁ and t₂ is between 27.5 and 30 nm.

18. The transparent substrate of claim 17, wherein the ratio of thicknesses t₁ to t₂ is between 0.9 and 1.

19. The transparent substrate of claim 17, wherein the sum of thicknesses t₁ and t₂ is between 28 and 29.5 nm.

20. The transparent substrate of claim 17, wherein the second transparent sheet with the stack of thin layers comprises the sequence
Glass/Si₃N₄/ZnO/Ag/Ti/Si₃N₄/ZnO/Ag/Ti/ZnO/Si₃N₄.

21. The transparent substrate of claim 11, wherein the transparent sheet has first and second faces, with the metal wires disposed on the first face and at least one conductive metal layer formed of silver disposed on the second face.

22. The transparent substrate of claim 21, wherein the stack of thin layers comprises at least two metal layers having properties in the infrared region, the metal layer closest to the substrate having a thickness t₁ and a second metal layer having a thickness t₂, wherein the ratio of thicknesses t₁ to t₂ is between 0.8 and 1.1 and the sum of thicknesses t₁ and t₂ is between 27.5 and 30 nm.

23. The transparent substrate of claim 22, wherein the ratio of thicknesses t₁ to t₂ is between 0.9 and 1.

24. The transparent substrate of claim 22, wherein the sum of thicknesses t₁ and t₂ is between 28 and 29.5 nm.

25. The transparent substrate of claim 22, wherein the second transparent sheet with the stack of thin layers comprises the sequence
Glass/Si₃N₄/ZnO/Ag/Ti/Si₃N₄/ZnO/Ag/Ti/ZnO/Si₃N₄.

26. The transparent substrate of claim 11, wherein the metal wires define a multiplicity of openings, the dimensions of the openings being non-uniform.

27. The transparent substrate of claim 26, wherein the openings define a first surface area and the metal wires are deposited on a second surface area, with the ratio of the first surface area to the second surface area being greater than 65%, and the substrate has a diffuse transmission of less than 2%.

28. The transparent substrate of claim 26, wherein internal edges of two adjacent metal wires are separated by a distance between 250 μm and 750 μm.

29. The transparent substrate of claim 11, wherein the substrate has a substantially parallelepiped shape and the metal wires are oriented transverse to edges of the substrate.

30. The transparent substrate of claim 11, wherein the metal wires are produced by a photolithographic or photoenamelling technique.

31. The transparent substrate of claim 11, wherein the metal wires are formed of copper or silver.

32. The transparent substrate of claim 11, further comprising a sheet of thermoplastic material covering the metal wires.

33. The transparent substrate of claim 11, wherein the metal wires are electrically connected to one another.

34. The transparent substrate of claim 11, wherein the metal wires are configured to be connected to earth.
